(19) United States
(12) Patent Application Publication
(10) Pub. No.: US 2014/0299066 A1
(43) Pub. Date: Oct. 9, 2014

(54) SHIELD FOR USE IN ANIMAL BATHING

(71) Applicant: Jonathan D Espaillat, Williamsburg, VA (US)

(72) Inventor: Jonathan D Espaillat, Williamsburg, VA (US)

(21) Appl. No.: 14/225,667

(22) Filed: Mar. 26, 2014

Related U.S. Application Data
(60) Provisional application No. 61/853,590, filed on Apr. 9, 2013.

(51) Int. Cl. A01K 1/02; A01K 13/00

(52) U.S. Cl. CPC A01K 1/02; A01K 13/001
USPC 119/452

(57) ABSTRACT

A shield for use in bathing an animal includes an open-floor tent having at least three sides and a top. Two of the three sides are in substantial opposition to one another. Each of the three sides has an opening defined therein. Streamers are coupled to the tent such that a first portion of the streamers is coupled to the tent to hang freely over the opening in a first of the three sides, and such that a second portion of the streamers is coupled to the tent to hang freely over the opening in a second of the three sides.

Pursuant to 35 U.S.C. §119, the benefit of priority from provisional application 61/853,590, with a filing date of Apr. 9, 2013, is claimed for this non-provisional application.

### FIELD OF THE INVENTION

The invention relates generally to animal bathing accessories, and more particularly to a shield placed over an animal when bathing the animal.

### BACKGROUND OF THE INVENTION

People bathe their household animals (e.g., dogs, cats, etc.) for cleanliness, to eliminate odor, prevent pest infestation, and so that the animals look good. Typically, such bathing is done indoors in a sink or tub, or outdoors when the weather permits. In either case, the animal is usually restrained with one hand and scrubbed with the other. At several times during this process, the animal shakes resulting in a spray of water and soap that soaks the bather and spreads out to the surrounding environment.

### SUMMARY OF THE INVENTION

Accordingly, it is an object of the present invention to provide a shield for use in bathing an animal.

Another object of the present invention is to provide a shield that defines a bathing space for an animal, provides a bather access to the animal's body, and captures substantially all of the spray that results when the animal shakes during bathing.

Other objects and advantages of the present invention will become more obvious hereinafter in the specification and drawings.

In accordance with the present invention, a shield for use in bathing an animal includes an open-floor tent that includes at least three sides and a top. A first of the three sides and a second of the three sides are in substantial opposition to one another. Each of the three sides has an opening defined therein. Streamers are coupled to the tent such that a first portion of the streamers is coupled to the tent to hang freely over the opening in the first of the three sides, and such that a second portion of the streamers is coupled to the tent to hang freely over the opening in the second of the three sides.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective view of a shield used for bathing an animal in accordance with an embodiment of the present invention;

FIG. 2 is a side view of the shield taken along line 2-2 in FIG. 1;

FIG. 3 is a top view of the shield shown in FIG. 1;

FIG. 4 is an end view of the shield taken along line 4-4 in FIG. 1;

FIG. 5A is an isolated view of streamers in an abutting side-by-side relationship in accordance with an embodiment of the present invention;

FIG. 5B is an isolated view of streamers in a spaced-apart side-by-side relationship in accordance with another embodiment of the present invention;

FIG. 5C is an isolated view of streamers of varying width in accordance with another embodiment of the present invention;

FIG. 6A is an isolated side view of streamers arranged in layers in accordance with an embodiment of the present invention;

FIG. 6B is an isolated side view of streamers arranged in layers with the streamers varying in length between the layers in accordance with another embodiment of the present invention;

FIG. 7A is an isolated head-on view of streamers arranged in layers with the streamers varying in length between the layers and with the streamers being aligned between the layers in accordance with an embodiment of the present invention;

FIG. 7B is an isolated head-on view of streamers arranged in layers with streamers varying in length between the layers and with the streamers being misaligned between the layers in accordance with another embodiment of the present invention;

FIG. 8 is a perspective view of a shield having a transparent top in accordance with another embodiment of the present invention;

FIG. 9 is a perspective view of a shield further having streamers hanging over the head opening of the shield in accordance with another embodiment of the present invention;

FIG. 10 is a perspective view of a shield constructed using flexible frame members coupled to a flexible-material shell in accordance with an embodiment of the present invention; and

FIG. 11 is a top view of a shield constructed to define a triangular footprint in accordance with another embodiment of the present invention.

### DETAILED DESCRIPTION OF THE INVENTION

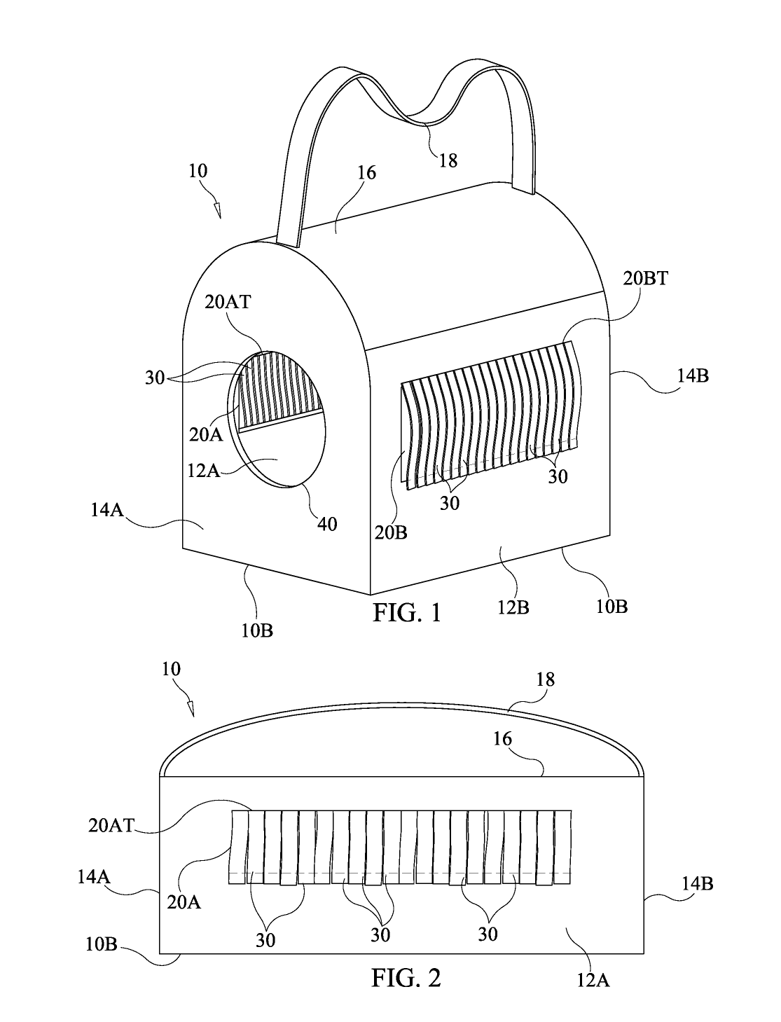

Referring now to the drawings, simultaneous reference will be made to FIGS. 1-4 where a shield for use in bathing an animal (not shown) in accordance with an embodiment of the present invention is shown and is referenced generally by numeral 10. In general, shield 10 is a self-supported tent-like structure having no floor, i.e., shield 10 is open on the bottom 10B thereof such that shield 10 can be placed over the top of an animal standing on the ground, in a tub, in a sink, etc. Shield 10 can be made from all flexible materials or a combination of rigid and flexible materials without departing from the scope of the present invention.

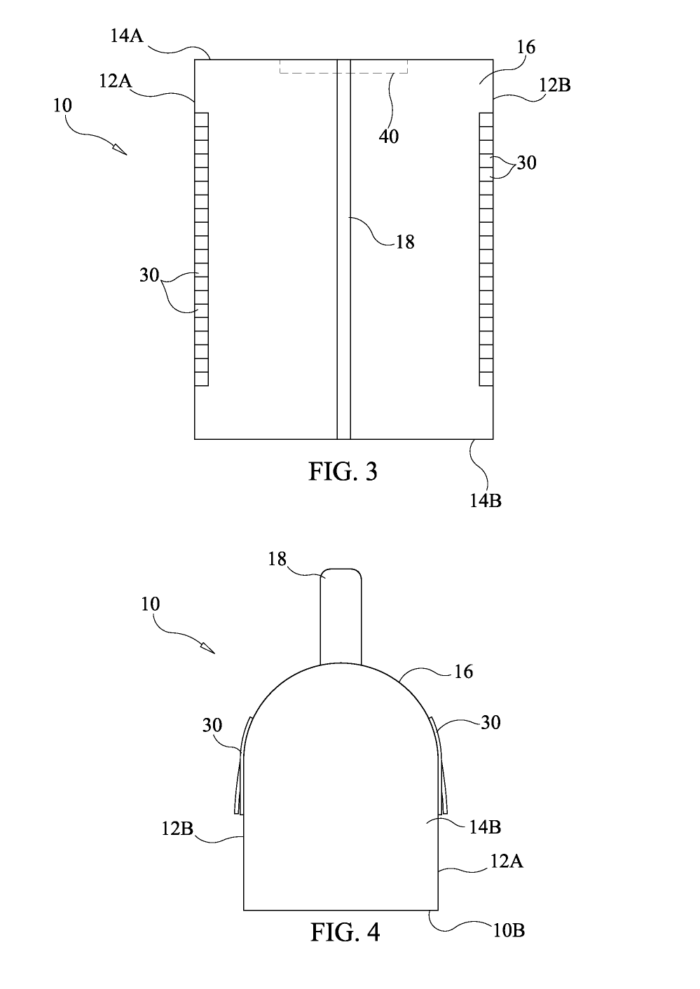

In the illustrated embodiment, shield 10 occupies a substantially rectangular footprint (as best seen in the FIG. 3 top view thereof) defined by opposing long sides 12A and 12B, and opposing short sides 14A and 14B. A top 16 is coupled to each of sides 12A, 12B, 14A and 14B. A carrying handle 18 can be provided and coupled to shield 10 at, for example, a portion of the interface where short sides 14A/14B meet top 16. Materials used for top 16 and sides 12A, 12B, 14A and 14 are generally selected to be water resistant or waterproof. Such materials can be treated or untreated, natural and/or man-made materials without departing from the scope of the present invention.

Each of long sides 12A and 12B has a corresponding elongated opening 20A and 20B formed therein that provides access to the interior of shield 10. That is, when shield 10 is positioned over an animal, the person bathing the animal can reach into shield 10 from one or both openings 20A and 20B. Covering each opening 20A and 20B are streamers 30 that are attached only at tops 20AT and 20BT of each opening 20A and 20B, respectively, such that each streamer 30 hangs freely down over a small portion of the corresponding opening. In this way, the collection of streamers 30 over each opening 20A and 20B does not impede access into shield 10, but does substantially present water spray from leaving openings 20A and 20B. Streamers 30 are made from materials that are water resistant or waterproof, and can be made from treated or untreated, natural and/or man-made materials without departing from the scope of the present invention.

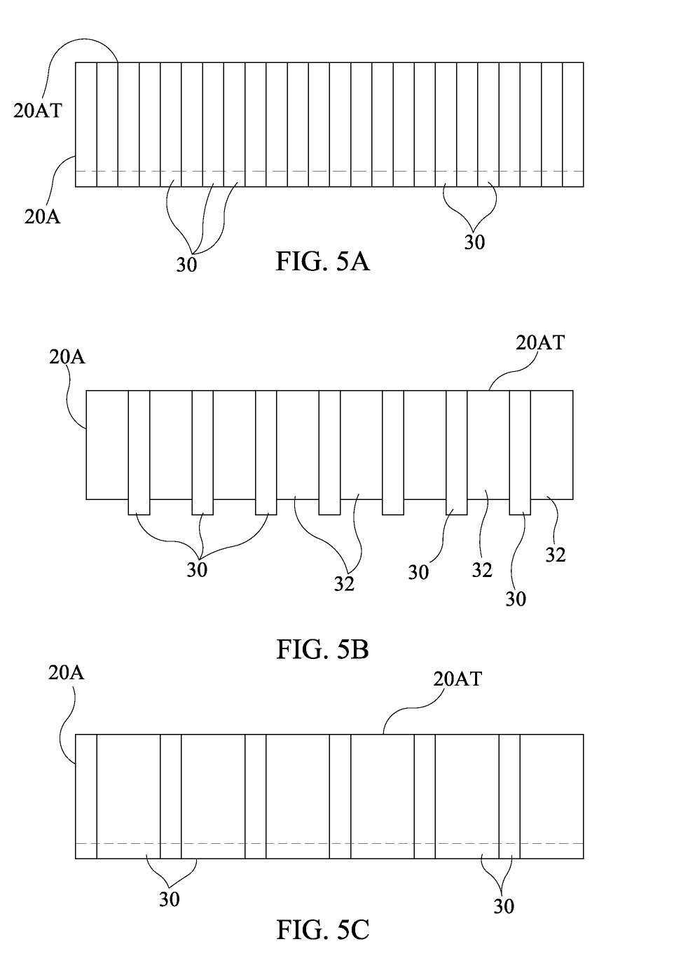

The particular configuration and construction of streamers 30 attached at the top of each opening 20A/20B is not a limitation of the present invention. For example, streamer construction/configuration at each opening 20A and 20B can be the same or different. Streamers 30 can be arranged in single or multiple layers. Several such non-limiting examples are illustrated in FIGS. 5A-7B and will be discussed briefly below. FIG. 5A shows streamers 30 arranged in a substantially abutting side-by-side relationship as would occur if a single piece of material had cuts made therein to define streamers 30. FIG. 5B illustrates another embodiment for streamers 30 in which adjacent streamers 30 are separated from one another by a gap 32. In FIG. 5C, streamers 30 are made to have different widths. Accordingly, it is to be understood that streamers 30 can be constructed/configured in other ways without departing from the scope of the present invention.

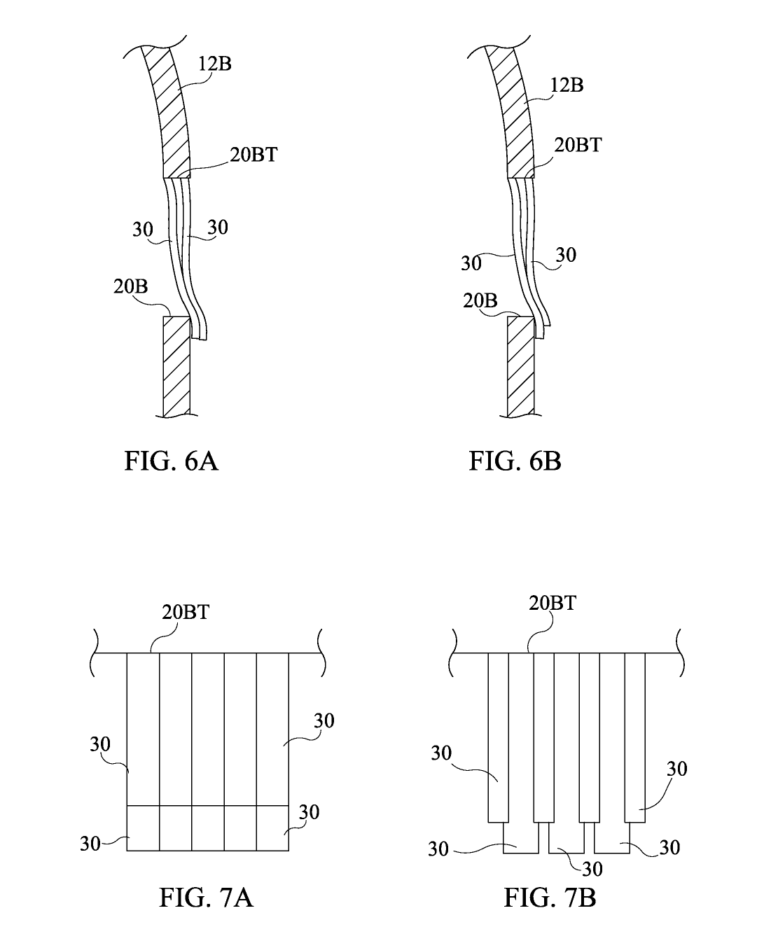

As mentioned above, streamers 30 can be arranged in multiple layers, as illustrated by the embodiments depicted in FIGS. 6A, 6B, 7A and 7B. More specifically, FIG. 6A illustrates two layers of streamers 30 at opening 20B with the lengths of streamers 30 in each layer being the same. FIG. 6B also illustrates two layers of streamers at opening 20B with the lengths of streamers 30 in each layer being different. It is to be understood that more (or less) than two layers of streamers can be used without departing from the scope of the present invention. In FIG. 7A, streamers 30 are arranged in two layers of different lengths and such that each streamer 30 is aligned with another streamer 30 in an adjacent layer. Another embodiment of the present invention is illustrated in FIG. 7B where streamers 30 are arranged in two layers of different lengths and such that each streamer 30 is misaligned with two adjacent streamers 30 in an adjacent layer.

Referring again to FIG. 1, short side 14A of shield 10 has an opening 40 formed therein. The particular size and shape of opening 40 is not a limitation of the present invention. In general, opening 40 defines a place for the animal's head to extend out of shield 10 to thereby prevent the animal from feeling caged while being bathed.

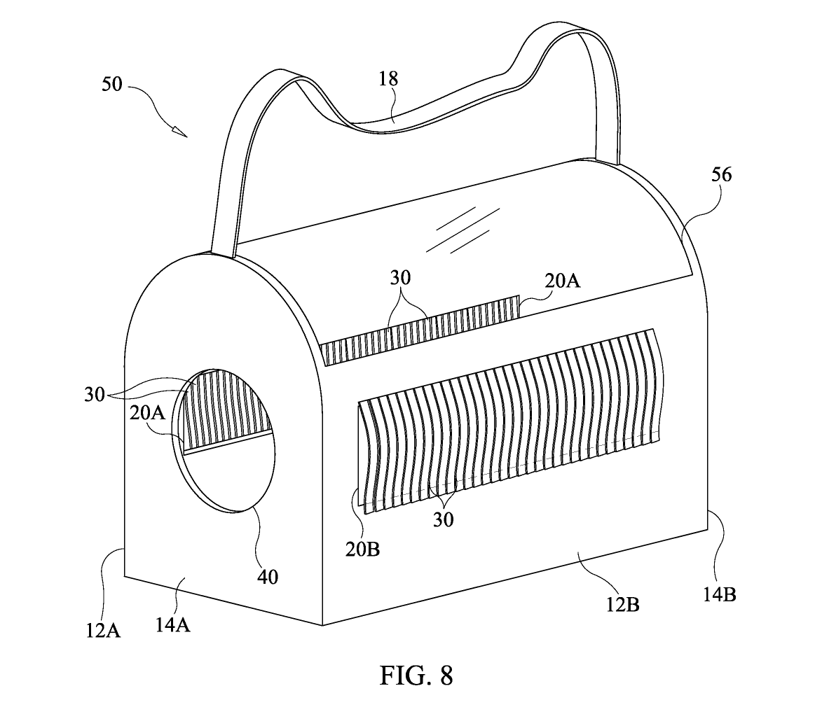

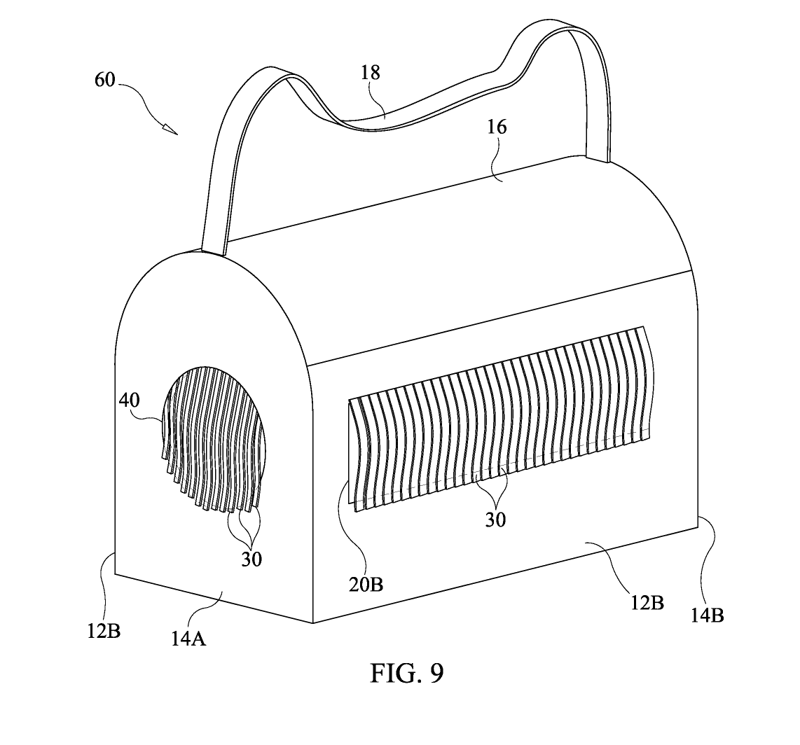

Additional embodiments of shields in accordance with the present invention will now be explained with reference to FIGS. 8-11. It is to be understood that one or more of the features presented in FIGS. 8-11 can be incorporated with a shield falling within the scope of the present invention. Reference numerals for elements/features already described herein will be used in FIGS. 8-11.

Referring first to FIG. 8, a shield 50 includes a top 56 that is made from a substantially transparent material (e.g., a clear plastic, vinyl, etc.). In this way, a person bathing an animal in shield 50 can see the animal while reaching into shield 50 via one or both of openings 20A and 20B which are covered by streamers 30 are described above.

In FIG. 9, a shield 60 also includes streamers 30 coupled to short side 14A such that the streamers hang freely over opening 40. This will allow an animal's head to poke through opening 40, but will substantially prevent any water spray from exiting shield 60 through opening 40.

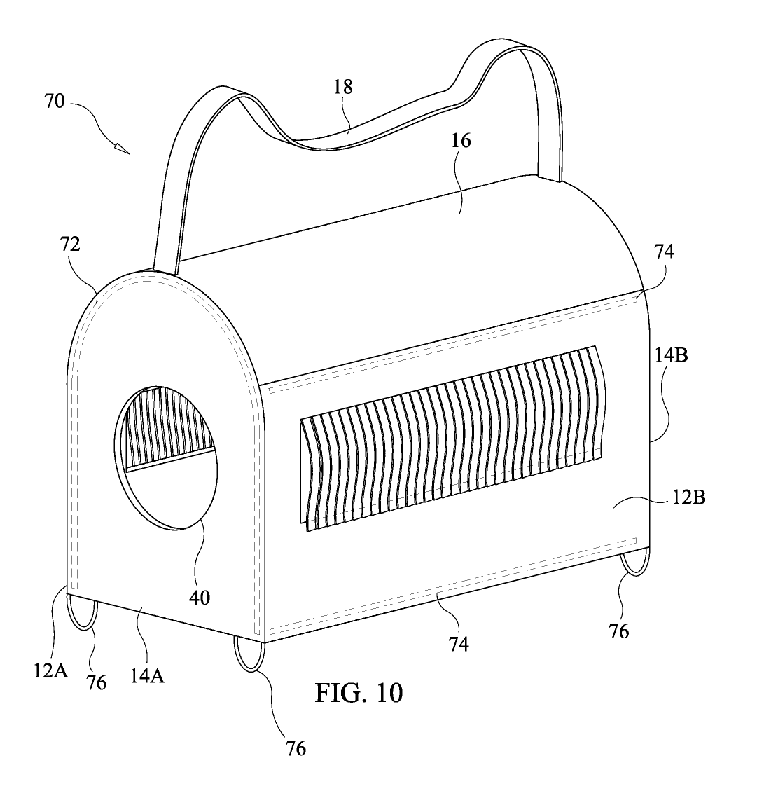

A shield 70 depicted in FIG. 10 illustrates some possible construction details in which top 16 and sides 12A/12B/14A/14B comprise flexible tent shell materials sewn together at their respective interfaces. Shield 70 is maintained in its tent shape by a plurality of flexible frame members (e.g., bendable plastic or metal, straight tubes coupled by an elastic member contained therein as used in the small tent industry, etc.) sewn into the tent shell or inserted into sleeves/pockets (not shown) of the tent shell as would be well understood in the art. For example, a shaped flexible frame member 72 could be used at the interface of short sides 14A with top 16 and sides 12A/12B. A similar frame member would be located at the other end of shield 70. Straight frame members 74 could be used along some or all of the open-bottom periphery of shield 70 and where top 16 interfaces with each of long sides 12A and 12B. Shield 70 can optionally include a plurality of stake loops 76 about its open-bottom periphery to facilitate the staking of shield 70 to a ground environment.

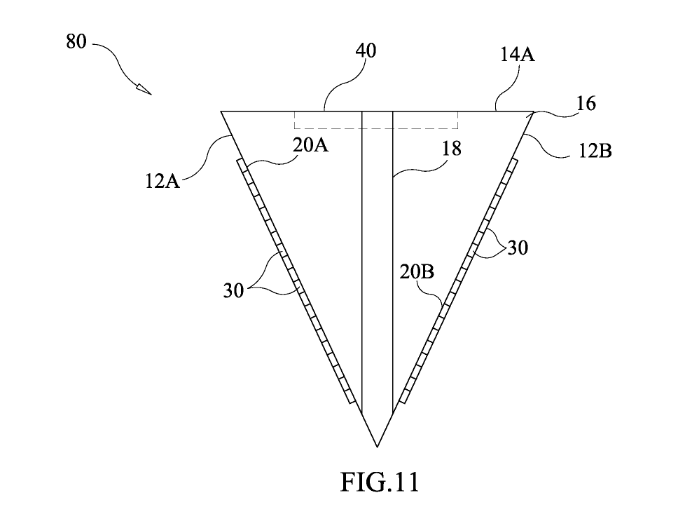

While the present invention has thus far been described for shields having a substantially rectangular footprint, it is not so limited. For example, FIG. 11 illustrates the top view of a shield 80 having only three sides to define a substantially triangular footprint. More specifically, shield 80 includes long side 12A and 12B having respective openings 20A and 20B covered with streamers 30, and just one short side 14A with opening 40 defined therein as described above. Shield 80 reduces the reach required for a bather to access both openings 20A and 20B simultaneously.

The advantages of the present invention are numerous. The shield is readily dropped over an animal at bath time to reduce/eliminate the spray of water and soap during bathing. The animal can poke his head out of the shield to prevent cage anxiety, while the bather has ready access to the animal for bathing. The shield defines a bathing space for the animal thereby minimizing the need to restrain the animal during bathing.

Although the invention has been described relative to a specific embodiment thereof, there are numerous variations and modifications that will be readily apparent to those skilled in the art in light of the above teachings. For example, the shield's sides and top could be made from rigid materials configured to collapse for storage purposes. It is therefore to be understood that, within the scope of the appended claims, the invention may be practiced other than as specifically described.

What is claimed as new and desired to be secured by Letters Patent of the United States is:

1. A shield for use in bathing an animal, comprising:
an open-floor tent that includes at least three sides and a top wherein a first of said three sides and a second of said three sides are in substantial opposition to one another, each of said three sides having an opening defined therein; and
a plurality of streamers coupled to said tent, wherein a first portion of said streamers is coupled to said tent to hang freely over said opening in said first of said three sides, and wherein a second portion of said streamers is coupled to said tent to hang freely over said opening in said second of said three sides.

2. A shield as in claim 1, wherein said tent and said streamers are selected from the group consisting of water-resistant flexible materials and waterproof flexible materials.

3. A shield as in claim 1, wherein at least a portion of said top is substantially transparent.

4. A shield as in claim 1, further comprising a handle coupled to said tent.

5. A shield as in claim 1, wherein each of said first portion of said streamers and said second portion of said streamers are arranged in layers.

6. A shield as in claim 1, wherein a third portion of said streamers are coupled to said tent to hang freely over said opening in a third of said three sides.

7. A shield as in claim 1, wherein said tent has a rectangular footprint.

8. A shield as in claim 1, wherein said streamers are arranged in a substantially abutting side-by-side relationship in each said first portion and said second portion thereof.

9. A shield as in claim 5 wherein, for each of said layers of said streamers, said streamers are arranged in a substantially abutting side-by-side relationship.

10. A shield as in claim 5, wherein lengths of said streamers vary between said layers.

11. A shield for use in bathing an animal, comprising:
a substantially rectangular and open-floor tent having a flexible tent shell shaped by a plurality of frame members coupled to said tent shell, said tent shell having four sides and a substantially transparent top, wherein a first of said four sides and a second of said four sides are in substantial opposition to one another and have substantially-opposed openings defined therein, and wherein a third of said four sides has an opening defined therein; and
a plurality of streamers coupled to said tent shell to hang freely over at least said substantially-opposed openings.

12. A shield as in claim 11, wherein said tent shell and said streamers are selected from the group consisting of water-resistant flexible materials and waterproof flexible materials.

13. A shield as in claim 11, further comprising a handle coupled to said tent.

14. A shield as in claim 1, wherein said streamers hanging freely over each of said substantially-opposed openings are arranged in layers.

15. A shield as in claim 11, wherein a portion of said streamers are coupled to said tent shell to hang freely over said opening in said third of said four sides.

16. A shield as in claim 11, wherein said streamers are arranged in a substantially abutting side-by-side relationship.

17. A shield as in claim 14 wherein, for each of said layers of said streamers, said streamers are arranged in a substantially abutting side-by-side relationship.

18. A shield as in claim 14, wherein lengths of said streamers vary between said layers.

19. A shield for use in bathing an animal, comprising:
an open-floor tent that includes at least three sides and a substantially transparent top wherein a first of said three sides and a second of said three sides are in substantial opposition to one another, each of said three sides having an opening defined therein;
a carrying handle coupled to said tent; and
a plurality of streamers coupled to said tent, wherein a first portion of said streamers is coupled to said tent to hang freely over said opening in said first of said three sides, and wherein a second portion of said streamers is coupled to said tent to hang freely over said opening in said second of said three sides, each of said first portion of said streamers and said second portion of said streamers defined by at least one layer of said streamers arranged in a side-by-side abutting relationship.

20. A shield as in claim 19, wherein said tent and said streamers are selected from the group consisting of water-resistant flexible materials and waterproof flexible materials.

21. A shield as in claim 19, wherein a third portion of said streamers are coupled to said tent to hang freely over said opening in a third of said three sides.

22. A shield as in claim 19, wherein said tent has a rectangular footprint.

23. A shield as in claim 19 wherein, for each of said first portion of said streamers and said second portion of said streamers, said at least one layer comprises a plurality of layers, and wherein lengths of said streamers vary between said layers.
